(19) United States
(12) Patent Application Publication
(10) Pub. No.: US 2014/0200862 A1
(43) Pub. Date: Jul. 17, 2014

(54) DRAWINGS AND COMPUTER-AIDED MODELING

(71) Applicant: Tekla Corporation, Espoo (FI)

(72) Inventors: Jari Sundqvist, Lohja (FI); Pia Nakari, Helsinki (FI); Charles Pool, Kennesaw, GA (US); Ville Rousu, Superior, CO (US)

(73) Assignee: Tekla Corporation, Espoo (FI)

(21) Appl. No.: 14/152,646

(22) Filed: Jan. 10, 2014

(30) Foreign Application Priority Data
Jan. 11, 2013 (FI) 20135034

(51) Int. Cl. G06F 17/50; G06T 17/00

(52) U.S. Cl. CPC G06F 17/50; G06T 17/00
USPC 703/1

(57) ABSTRACT

To facilitate reading out information relating to an object, a drawing is split according to one or more splitting rules to one or more split drawings before it is outputted, a split drawing showing at least one of the objects or one or more pieces of the related information in a way other than it will be shown in the drawing.

### RELATED APPLICATION

This application claims priority to FI application no. 20135034 filed Jan. 11, 2013, which is assigned to the applicant of the present application and is hereby incorporated by reference in its entirety for all purposes.

### FIELD

The invention relates to computer-aided modeling and, particularly, information obtainable via drawings.

### BACKGROUND

Modeling means that a model is created from an object under design for describing the object to be manufactured. The development of data processing systems and computers has transformed modeling into a computerized process, where also drawings are produced from the model. The purpose of a drawing is to capture the engineering design accurately and unambiguously, such as to, capture all the geometric features of the object. In other words, the end goal of such a drawing is to convey all the required information that will allow a manufacturer to produce the object.

Drawings are usually created in accordance with standardized conventions for layout, nomenclature, interpretation, appearance, size, etc. Each field of engineering has its own requirements for drawings. Drawings typically include at least geometry, i.e. the shape of the object(s) and dimensions defining the size of the object(s) in accepted units, and they may include tolerances determining allowable variations for each dimension, and/or material describing what the object(s) will be made of, and/or information specifying the surface quality of the object(s). Thus, the amount of information in a single drawing may be huge. Therefore the drawing is rather difficult to read and the reading is prone to errors.

### SUMMARY

The invention relates to a method, a program product and an apparatus which are characterized by what is stated in the independent claims. The preferred embodiments are disclosed in the dependent claims.

An aspect provides a solution in which at least one piece of information is outputted in a split drawing in a way other than the way defined for the piece of information for a drawing. For example, only some pieces of the information included in a drawing of the model are outputted (shown and/or printed) at a time, the outputted information being selected by means of one or more splitting rules.

An advantage provided by the aspect is that it facilitates needs oriented drawing information presentation, making it easier to understand and only showing the information needed at that time without having to generate and store such presentations separately in advance, since they are easily obtainable from drawing data by applying the splitting rule(s), the drawing outputted by using the drawing data still fulfilling the drawing requirements laid down in regulations and containing all information it should contain.

### BRIEF DESCRIPTION OF THE DRAWINGS

In the following different embodiments of the invention will be described in greater detail with reference to the attached drawings, in which:

FIG. 1 shows a simplified architecture of an exemplary system and a schematic block diagram of an exemplary apparatus;

FIGS. 2 and 3 are flowcharts illustrating examples of splitting; and

FIG. 4A illustrates an outputted drawing file;

FIGS. 4B to 4E illustrate examples of outcomes of the process illustrated in FIG. 2 or FIG. 3; and

FIG. 5 illustrates different annotation possibilities amongst which one may be selected for a split drawing.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment.

The present invention is applicable to any computer-aided modeling system that can produce drawings from stored drawing data. In the following, the invention will be described by using an exemplary evolved system that utilizes a run-time database comprising information to be stored and already stored in a disc memory of an apparatus, without restricting the invention thereto. In another embodiment of the invention, an object-oriented database or a relation database, for example, can be utilized and used over a network, for instance. Various programming techniques, storage of data in memory and manners of implementing databases develop constantly. This may require extra changes in the invention. Consequently, all terms and expressions should be interpreted broadly, and they are intended to describe, not to restrict, the invention.

Below the invention will be described in more detail with an exemplary system in which drawing data for a drawing is stored in a drawing file without limiting the invention to such a solution to store drawing data.

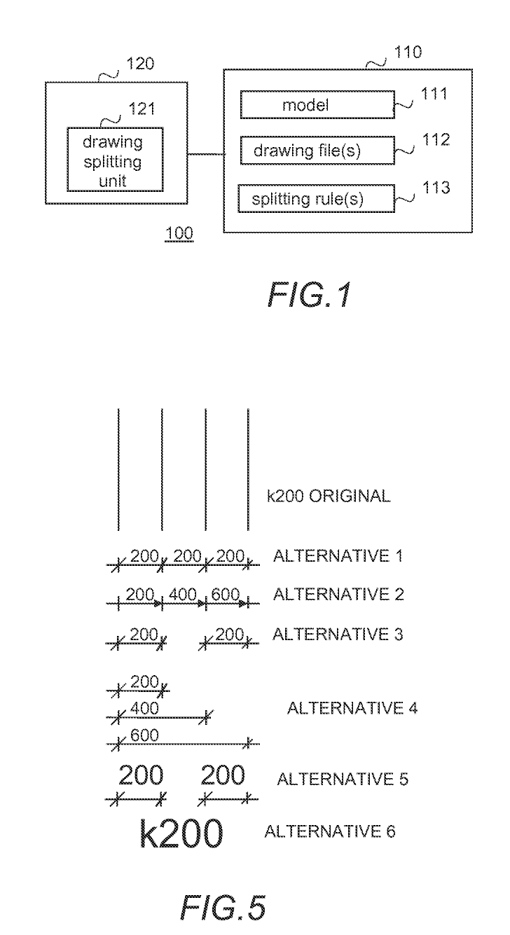

FIG. 1 illustrates a simplified modeling system describing only some logical units with their operative connections, the implementation of which may deviate from what is presented. It is obvious to a person skilled in the art that the system may also comprise other functions and structures that need not be described in greater detail here. The more detailed structure of the system is irrelevant to the actual invention.

The modeling system 100 illustrated in FIG. 1 comprises data storage 110 that is accessible by an apparatus 120.

In the illustrated example, the data storage 110 comprises a model 111 that represents, by means of different parts (object definitions), a structure to be constructed, and at least one drawing created for the model and stored in the form of a drawing file 112 comprising reference(s), like identifiers, to parts in the model, and one or more drawing views, each with a corresponding coordinate system, and so-called drawing objects and related information including annotations, like dimensions, marks, texts, etc. By means of the references, those parts and their definitions are obtained from the model 111 when a drawing is opened, and thus they are always up-to-date. In other words, the object definitions define the geometry of the part and by means of the references the geometry and its changes is propagated to the drawings, although object definitions and drawing data are separate from each other. The drawing views and the drawing objects define how and with which information the selected parts are outputted. It should be appreciated that in another system a drawing file may contain graphics instead of the above or only some of the above described definitions and relationships. Regardless of the system used and the way of storing drawing data, one can say that drawing data for a drawing contains drawing definitions which are used when a drawing is outputted and which define what is in the drawing and how it is outputted. In other words, the drawing data is a plan of drawing that typically, but not necessarily, includes definitions of a sheet size and the drawing views to be included to the drawing, and a table layout. A drawing view is a predefined, fixed view that cannot be used for modeling, and typically does not change according to the user's view angle, view direction etc., whereas a view (i.e. a model view) displayed during modeling, for example, changes and, hence, provides a navigateable view changing according to “movement” in the model. It should be appreciated that a fixed view is zoomable when outputted on a display. Examples of drawing views include main views, section views, and single-part views. The table layout defines selection, placing and scale of tables in a drawing, when such tables are used. A table may be a box in a drawing that may include one or more of the following: real-life parts represented by corresponding objects in the drawing, revision tables, title blocks, bills of material, lists, general notes, etc. Examples of different engineering and/or manufacturing drawings include single-part drawings, assembly drawings, cast unit drawings, general arrangement drawings, and multidrawings that gather together several drawings on one sheet. To summon up, a drawing comprises one or more fixed views, and a drawing may comprise different fixed views of the same object and/or a combination of objects and/or a fixed view may be created only to a detail of an object.

A further difference between a drawing and the model view is that for a drawing, definitions are created and stored, whereas the model view is created “on fly” from the model information using the object definitions, and no specific view-related information is stored or defined. The model view is typically a three dimensional view and, as said above, the model view changes according to the user's view angle, view direction, etc. when the user studies the model and navigates in the model. The drawing is typically, but not necessarily, a two dimensional representation, although a drawing view may create an illusion that it is a three dimensional view (i.e. it has flattened the three dimensions to two dimensions). Typically, but not necessary, a model view is displayed in a modeling mode, and a drawing is displayed/outputted only if the user specifically selects to manipulate (including displaying, outputting) a drawing, i.e. is in a drawing mode, the drawing mode not providing such possibilities to revise (model) the actual model as the modeling mode.

In the illustrated example, the data storage 110 comprises one or more splitting rules 113. A splitting rule contains definitions on the basis of which a drawing may be “split”, as will be described in detail below. A splitting rule may be a bill of material, checking table, manufacturing order, assembly order, a user-defined order, or any combination thereof. An order may be material-specific, maker-specific, working phase-specific, etc. A splitting rule may further contain a definition to add some annotations and/or to use other kind of annotation(s) than what is used in the actual drawing (i.e. drawing that is not split) and/or to output some additional information that is useful in the split drawing but not illustrated in the actual drawing. The splitting rule itself may contain the additional information or a pointer where to obtain (or retrieve) it. For example, some information may be obtained (retrieved) from working instructions. The user-defined order may be stored permanently or it may be a temporary file, which is, for example, created online and real-time in response to user selections and which is only used once. There may be several sets of splitting rules for one drawing, a set being selected according to the purpose of the splitting. Hence, there are no restrictions to the splitting rules, and a splitting rule may be predefined, ad hoc defined or any combination thereof. It is obvious to a person skilled in the art that the above described data (such as splitting rules and possible specific annotations or additional information) can be stored in one or more files (even as part of drawing data) and/or they can be stored/processed in another form and/or by using other memories.

In the following a term “part” is used in a meaning of a modeled object representing a real-life article or being closely related to it, like a column, a beam, a wall, a bolt, a rebar, a hole for a bolt, etc., and “annotation” is used for additional information provided in a drawing i.e. information that is only relevant to the drawing, like dimension lines, dimension texts, etc. Further, the information stored by means of the model and drawing file(s) to create drawings is referred below as drawing definitions.

The apparatus 120 may be any apparatus with which the model and/or drawings for the model may be created and/or edited and/or viewed. Examples of apparatuses include a user terminal or a work station, such as a laptop, a smartphone, a personal computer, a tablet computer, a field device, an e-reading device, a smart phone, a printer or a screen or a projector with some processing capabilities, or a personal digital assistant (PDA), or a server, like a cloud server or a grid server. More precisely, the apparatus 120 is a computing device configured to perform one or more of apparatus functionalities described with an embodiment, and it may be configured to perform functionalities from different embodiments. For this purpose, the network node comprises a drawing splitting unit 121 for splitting the information in a drawing to information shown/highlighted and to information not shown/flattened. The drawing splitting unit 121 may be configured to add or show differently one or more annotations according to the splitting rules. The drawing splitting unit 121 may be a separate unit or integrated to another unit in the apparatus. In another embodiment of the invention, the drawing splitting unit 121 may be divided into separate units, such as one unit for checking purpose and another unit for manufacturing or a corresponding purpose. In other words, the apparatus comprises not only prior art means, but also means for implementing functionality described with an embodiment/example and it may comprise separate means for each separate function, or means may be configured to perform two or more functions, and even to combine functions of different embodiments/examples. These means may be implemented by various techniques. For example, the means may be implemented in hardware (one or more apparatuses), firmware (one or more apparatuses), or software (one or more modules) components (recorded indelibly on a medium such as read-only-memory or embodied in hard-wired computer circuitry), or combinations thereof. For a firmware or software, implementation can be realized through units/modules (e.g., procedures, functions, and so on) that perform the functions described herein. Coding of software for carrying out the steps shown and described below is well within the scope of a person of ordinary skill in the art.

An apparatus implementing functionality or some functionality according to an embodiment may generally include a processor (not shown in FIG. 1), controller, control unit, micro-controller, or the like connected to a memory and to various interfaces of the apparatus. Generally the processor is a central processing unit, but the processor may be an additional operation processor. The drawing splitting unit 121 may be configured as a computer or a processor, or a microprocessor, such as a single-chip computer element, or as a chipset, including at least a memory for providing storage area used for arithmetic operation and an operation processor for executing the arithmetic operation. The drawing splitting unit 121 may comprise one or more computer processors, application-specific integrated circuits (ASIC), digital signal processors (DSP), digital signal processing devices (DSPD), programmable logic devices (PLD), field-programmable gate arrays (FPGA), and/or other hardware components that have been programmed in such a way that they carry out one or more functions of one or more embodiments. An embodiment provides a computer program embodied on any client-readable distribution/data storage medium or memory unit(s) or article(s) of manufacture, comprising program instructions executable by one or more processors/computers, which instructions, when loaded into an apparatus, constitute the editing unit and/or the transaction manager unit. Programs, also called program products, including software routines, program snippets constituting “program libraries”, applets and macros, can be stored in any medium, and may be downloaded into an apparatus. The data storage medium or the memory unit may be implemented within the processor/computer or external to the processor/computer, in which case it can be communicatively coupled to the processor/computer via various means as is known in the art. In other words, the drawing splitting unit 121 may be an element that comprises one or more arithmetic logic units, and a number of special registers and control circuits.

Further, the apparatus may comprise other units, and it comprises different interface units, such as a user interface (not illustrated in FIG. 1) for receiving different inputs, so that a user can create a model, modify the model, study it, print or otherwise output desired drawings and reports of the model, view the drawings beforehand, input information to the model, etc., and an outputting unit (not illustrated in FIG. 1) for providing different outputs, like drawings printed on paper or to a file or shown on a screen or by means of light beams forming the drawing to a mold, for example. The apparatus may further comprise one or more receiving units and/or transmitting units (including a transmitter and/or a receiver or a corresponding means for receiving and/or transmitting information) so that user data, content, control information, signaling and/or messages can be received and/or transmitted.

The apparatus may generally include volatile and/or non-volatile memory, which is in the illustrated example included in the data storage and may be configured to store splitting information at least as long as it is needed for showing it to a user when the user wants to view the split information and/or to print split information. The memory may also store computer program code such as software applications (for the drawing splitting unit 121, for example) or operating systems, information, data, content or the like for the processor to perform steps associated with the operation of the apparatus in accordance with embodiments. The memory may be, for example, EEPROM, ROM, PROM, RAM, DRAM, SRAM, firmware, programmable logic, hard drive, or other fixed data memory or storage device, etc., and it typically stores content, data, or the like. Further, the memory, or part of it, may be a removable memory detachably connected to the apparatus or a cloud-based memory attachable to the apparatus via a communication connection.

It should be appreciated that the apparatus may comprise other units used in or for modeling. However, they are irrelevant to the actual invention and, therefore, they need not be discussed in more detail here.

Although the apparatus has been depicted as one unity, different units and modules and memory may be implemented in one or more physical or logical units. For example, the drawing splitting unit 121 may comprise separate unit for each purpose, such as a checking procedure unit and a manufacturing drawing unit. Different embodiments of such an apparatus or, more precisely, different examples of a functionality of the drawing splitting unit 121 are described in more detail below.

The modeling system illustrated in FIG. 1 represents the simplest modeling system. In larger modeling systems, the apparatus may be a terminal and the data storage a database with which the terminal communicates via a server. In such a system, the server may be configured to perform one or more of the drawing splitting unit functionalities. The data storage may be any kind of conventional or future data repository, including distributed and centralized storing of data, managed by any suitable management system. An example of distributed storing includes a cloud-based storage in a cloud environment (which may be a public cloud, a community cloud, a private cloud, or a hybrid cloud, for example). The implementation of the data storage, the manner how data is stored, retrieved and updated, and the location where the splitting of a drawing is performed are irrelevant to the invention. Further, the modeling system may comprise several terminals and servers with databases, which are preferably integrated to be visible to the user as one database and one database server.

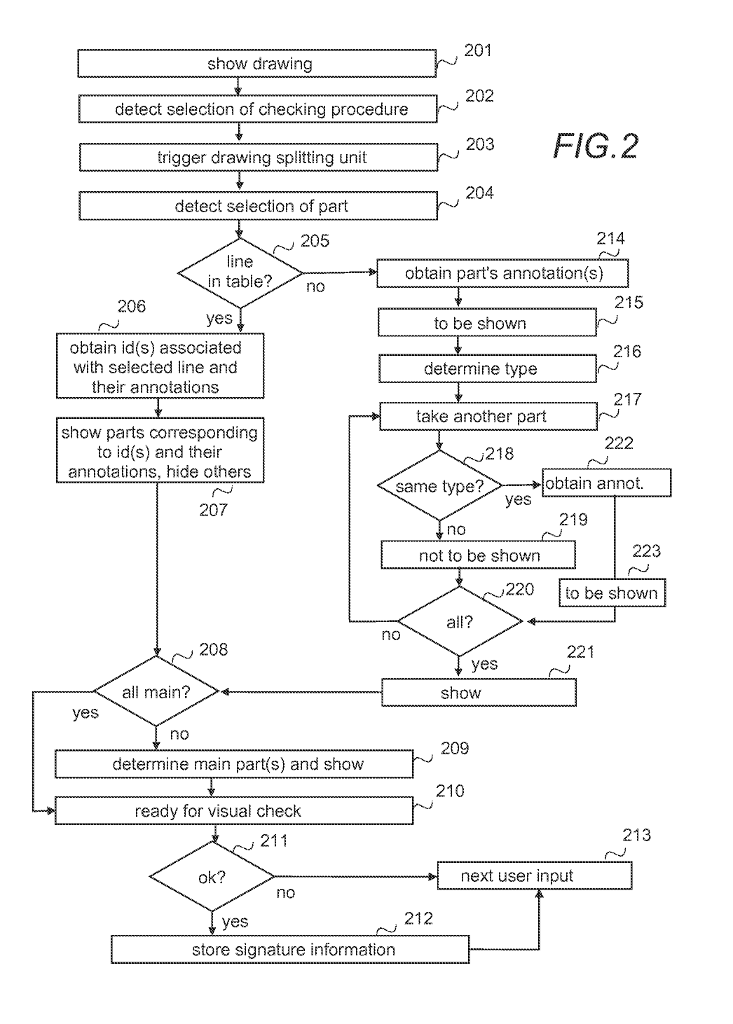

FIG. 2 is a flow chart illustrating a so-called checking procedure, which here means a procedure with which the user can check that all relevant data is provided and/or data is correct in the original drawing and that the splitting unit provides a checking tool. In the example described below, the drawing has been opened when the user wants to make sure that all drawing definitions are provided and the user selects the checking procedure. Further, in the example it is assumed that a checking table is used for determining splitting rules. There are no restrictions on contents of the checking table, but only information that associates or should associate with one or more modeled objects is usable (can be used) for checking purposes. The checking table may correspond to a bill of material or to a combination of the bill of material and additional information not shown in the bill of material, like “hole”, “mold”, etc., and/or the user may have defined the contents of the checking table or part of it. The checking table, as well as a user selection or any other selection method, may allow selection of two or more parts, but below, for the sake of clarity, the example is illustrated assuming that only one part is selected. In addition, in the illustrated example, the checking table has a column or a corresponding place for a user signature that indicates that the part is checked and accepted.

Referring to FIG. 2, the drawing is shown to a user in step 201. In the example, the drawing file comprises building objects and annotation objects. A building object represents something that will exist in a real building. In this example, annotation objects cover the drawing objects and drawing views.

The apparatus detects, in step 202, that a checking procedure is selected. Therefore the drawing splitting unit is triggered, in step 203, to wait for a part to be selected. Then it is detected, in step 204, that the user has selected a part. The part may be selected by selecting a line in the checking table or by selecting (clicking, for example) a part or an annotation in the shown drawing.

If the part was selected by means of the checking table (step 205), each identifier associated with the selected line and referring to a part in the model and corresponding annotations are obtained in step 206. Then the parts corresponding to the obtained identifiers and the obtained annotations are shown in step 207, and the other parts and their annotations, as well as other drawing information, are hidden.

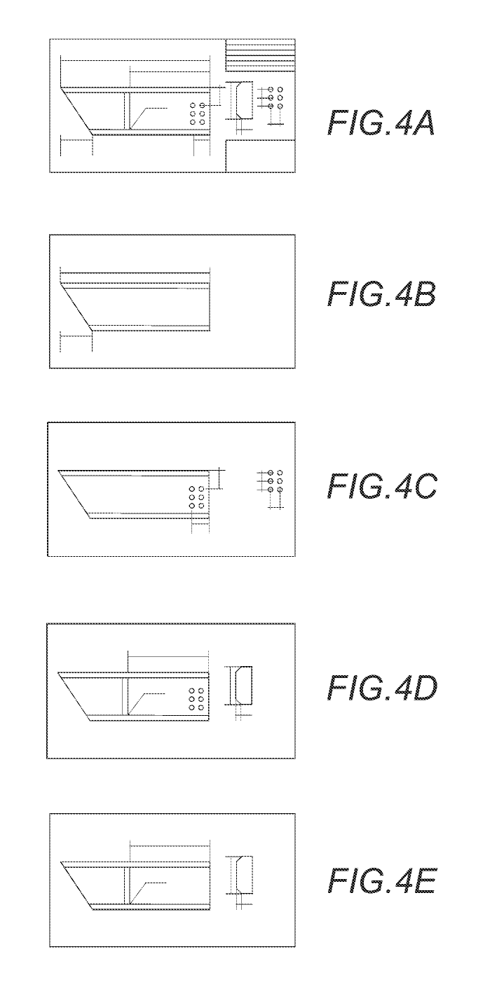

Then it is checked, in step 208, whether or not all shown parts are “main” parts. Herein, a main part is a part that is used as a basis for at least one dimension point for a dimension of the selected part. Preferably but not necessarily, a main part may exist alone, which means that it itself is not connected to another part, but other parts (that are not main parts) may be connected to it. Further, a part having a main part may be a main part for another part. For example, in the example illustrated in FIG. 4A, a beam is the main part, whereas holes and a stiffener are not main parts. Should the stiffener have holes, the stiffener would be the main part for those holes.

If at least one of the parts shown is not a main part (step 208), a main part is determined and shown, in step 209, for each such part. Then the split drawing is, in step 210, ready for visual check. In other words, the outcome of the process is shown to the user in step 210. For example, if the split drawing is for the stiffener in FIG. 4A, the split drawing is the one shown in FIG. 4E. Thus, it is easy to check, whether or not all required dimensions, etc. are modeled and whether there are unnecessary annotations. Therefore, in the example, it is monitored, in step 211, whether or not the user clicks an “ok” button provided for acceptance. The “ok” button is an example of an acknowledgement tool that may be provided with a split drawing. If the user clicks the “ok” button, a signature is added and stored in step 212 to the checking table for this part. The signature is added in this example automatically by storing the user's identification or credentials with which the user has logged into the system or to the modeling application, for example. In an implementation also the time when the signature is added and stored, i.e. a signature creation time, is also stored. Then the process proceeds to step 213 to wait for detection of the user's next action, like a selection of another part or exiting the checking.

However, if the user is not willing to sign the document (step 212), the user's next action, other than clicking the “ok” button, is detected in step 213. The next action may be a selection of another part, exiting the checking, the user may start to correct the drawing, or information on a detected error is sent to one who has created the drawing so that he/she can correct the drawing definitions or the original model. For example, if a dimension is missing, an editing mode may be triggered without any specific user command; it is sufficient that the user starts to add a dimension. Correspondingly, if there is a dimension that is unrelated to what is shown, it suffices that the user starts to delete the dimension.

If each part shown is a main part (step 208), the split drawing is, in step 210, ready for a visual check. For example, if the split drawing is for the beam in FIG. 4A, the split beam drawing is the one shown in FIG. 4B.

If the part was selected via the drawing shown to the user (step 205) by selecting (clicking, for example) a part or an annotation in the shown drawing, corresponding annotation(s) or part(s), accordingly, are obtained in step 214, and the part(s) and annotation(s) are marked, in step 215, as “to be shown”. Then the type of the part is determined, in step 216, and the rest of the drawing is processed. The process starts by taking, in step 217, another part in the drawing, and determining, in step 218, whether or not it is of the same type as the selected part. If the other part is not of the same type (step 218), the other part is marked, in step 219, as “not to be shown”, and then it is checked, in step 220, whether or not all parts in the drawing are processed. If all parts are processed, the parts and annotations that are marked as “to be shown” are shown, in step 221 and the parts that are marked as “not to be shown”, are hidden (i.e. not shown). Then the process continues to the above described step 208 to determine whether or not all shown parts are main parts.

If all parts are not processed (step 220), the process continues to step 217 to take another part to be processed.

If the other part is of the same type as the selected part (step 218), corresponding one or more annotations are obtained, in step 222, and the other part with its annotation(s) is marked, in step 223, as “to be shown”. Then the process proceeds to step 220 to check whether or not all parts in the drawing are processed.

Although in the above example, the drawing splitting unit is configured to split the objects to “to be shown” and “not to be shown”, it should be appreciated that any other means for visually differentiating the objects may be used. For example, instead of “to be shown”, the objects may be highlighted, shown in red, violet etc. and instead of “not to be shown”, the objects may be shown in light grey, black, flattened, etc. In these embodiments, checking of main part(s), i.e. steps 208 and 209 may be skipped over since the main part(s) remain in any case visible to the user.

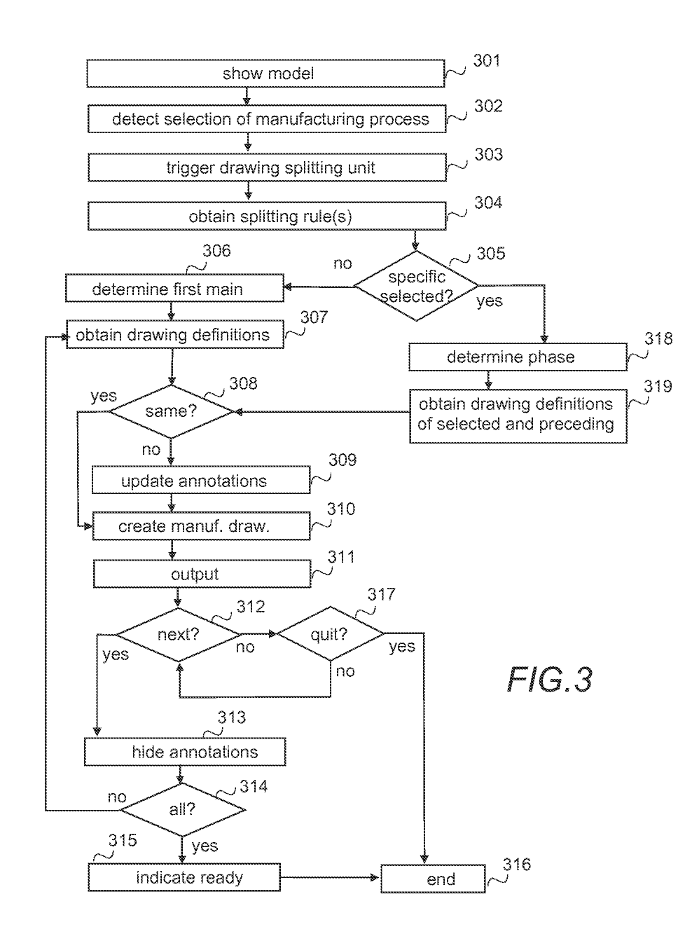

FIG. 3 is a flow chart illustrating an example where manufacturing drawings are created, and corresponding drawings are illustrated in FIGS. 4B to 4D. The very simplified example relates to manufacturing drawings for a steel beam. The same principles may be used for providing working drawings and assembly drawings, for example.

Referring to FIG. 3, a model or a drawing of a model is shown to the user in step 301. In the illustrated example the user may see the drawing shown in FIG. 4A. Then the apparatus detects, in step 302, that a manufacturing drawing creation procedure is selected. Therefore the drawing splitting unit is triggered, in step 303, for the manufacturing drawing creation. Further, a splitting rule for manufacturing, such as a manufacturing order, is obtained, in step 304. The splitting rule may be obtained for each part in the model, or in the drawing of the model shown to the user, i.e. for each main part that is shown to the user, or for each main part selected by the user prior to selecting the manufacturing drawing creation procedure. It is irrelevant for the invention when, how and by whom the manufacturing order is created, it suffices that the order can be mapped to the parts. For example, the mapping may be performed by means of identifiers or it may be based on the type or the type group. One example for a manufacturing phase “drill holes” is that all holes with corresponding dimensions may be obtained, or sequentially obtained, in the order of “from the biggest diameter to the smallest”, or vice versa. Another example is that plates are arranged according to their thickness, such that first plates having a thickness of 20 mm are to be welded first, plates having a thickness of 16 mm next. Yet another example is to first weld those plates for which a 6 mm weld is used, and then those for which a 4 mm weld is used.

To create manufacturing drawings, the drawing splitting unit determines, in step 305, whether or not a specific part was selected by the user. The user may select a specific part by clicking it before selecting the manufacturing drawings procedure, or the user may select a specific phase, for example, from the manufacturing order. It should be appreciated that in an embodiment providing an acknowledgment tool associated with a split drawing for a user signature, for example, by clicking a “done” button or a box when the phase has been finished in a similar way as described above with FIG. 2, the splitting module may be configured to maintain that information, or at least the information wherefrom to continue, and to select a next not-finished part as a specific selection without any further user interaction when the model is next time opened for the manufacturing process.

If no specific part was selected by the user (step 305), the manufacturing drawings are, at least in principle, prepared for all parts in the drawing. In the illustrated example, there are three different parts: beam, one set of holes, and stiffener, the beam being the only main part. The manufacturing drawings are created according to the manufacturing order. Therefore the first main part is determined, in step 306, by using the manufacturing order. Then the drawing definitions of the part in questions are obtained, in step 307, by means of the part identifier. Since in the illustrated example the manufacturing order may contain specific instructions to the annotations, it is checked, in step 308, whether or not the same annotation as in the drawing is used for the part in question. Depending on an implementation, the checking step may comprise prompting the user to select which one of the possible annotations should be used for the part in question. For example, for cutting the other end of the beam (FIG. 4B), an angle value may be more useful than the shorter dimension. FIG. 5 illustrates some annotation examples showing an annotation in the original drawing and alternative annotations that may be more usable in field conditions for a part (rebar) without limiting alternative annotations to the shown examples. Herein the annotations (and other styles) also cover additional information that is to be shown in a split drawing but not in the actual drawing. Examples of such additional information include information on the surface finishing of the steel beam, such as abraded, polished or sanded, and information on the welding method to be used or the weld thickness or the weld quality class. If another annotation is to be used (step 308), the annotations of the part in question are updated, in step 309, to be in accordance with the other annotation. Then a manufacturing drawing is created, in step 310, by means of the part in questions and its annotations, its main part, and the preceding parts. (The annotations of the preceding parts are not included in the manufacturing drawing.) The created manufacturing drawing is then outputted, in step 311. In other words, it may be shown to the user via a user interface or printed to a sheet or a file. Since the preceding parts are included without annotations, the outputted split drawing facilitates the person manufacturing the article to detect errors, such as phases that were not performed. For example, if the drilling phase has not been performed when the plate is welded, a welder notices it easily, since the outputted manufacturing drawing is the one shown in FIG. 4D but the beam looks like the one in FIG. 4E (without annotations).

In the illustrated example, the manufacturing drawing is outputted as long as the user indicates either that it is time to prepare the next manufacturing drawing (step 312) or that the user wants to quit (step 317).

In response to the user selecting “next” (step 312), the currently shown annotations are hidden, in step 313, and it is checked, in step 314, whether or not all parts are processed. If not, the process proceeds to step 307 to obtain drawing definitions of the part in question and continues as described above. It should be appreciated that since drawing definitions of the preceding parts are already obtained, they are not obtained in step 307 in this example without restricting the embodiment to the exemplary solution.

If all parts are processed (step 314), the user is provided, in step 315, with a “ready” indication to inform the user that the manufacturing of the article is completed, at least in the sense of the manufacturing drawings. Then the process ends in step 316. For example, referring to FIGS. 4A to 4D, the process ends when all FIGS. 4B to 4D all have been created, unless the user quits earlier.

If the user selects to quit (step 317), the process ends in step 316.

If a specific part is selected (step 305), the manufacturing phase of the selected part is determined, in step 318, for example, by means of the part identifier. The user may want to select a specific part in case the user has quitted earlier and now wants to continue, or knows the part which to manufacture or knows that phases 1 and 2 of the manufacturing are performed, for example. Then, the drawing definitions of parts that are precede the selected part in the manufacturing order and the drawing definitions of the part in question are obtained, in step 319, by means of the part identifier(s), for example. It should be appreciated that it is not necessary to obtain annotations of the preceding part(s). Since, as described above, in the illustrated example the manufacturing order may contain specific instructions to annotations, the process then continues to step 307 to check, whether or not the same annotation(s) as in the drawing is/are used for the part in question.

In the above example it is assumed that, when a manufacturing drawing is created directly after another manufacturing drawing has been created, the subsequent manufacturing drawings are created according to the manufacturing order. However, it should be appreciated that, in addition to or instead of selecting “next”, the user may be allowed to select a specific part.

As is evident from FIGS. 4A to 4D, simplified drawing views 4B to 4D, each presenting only information needed for one step in a manufacturing (fabrication) procedure and obtained by the process described above, make the manufacturing procedure less vulnerable to reading errors compared to a situation in which the assembly drawing of FIG. 4A should be used in all steps.

If the same annotations as in the actual drawing are used in each split drawing and the split drawings are superimposed one upon another, the result is equivalent to the drawing that is split in the manufacturing process and in the checking process.

When the user views the drawings by means of an apparatus having a smaller display (smaller than a traditional A3 paper format), the user can utilize either the checking procedure or the manufacturing procedure to obtain a more easily readable drawing that only shows the information currently needed by the user.

The above described selections and splitting rule(s) illustrate different ways to determine one or more splitting rules according to which a drawing may be split to output drawings containing information needed for that specific purpose, i.e. to output a split drawing that shows a piece of information differently from (in a different manner than) what will be shown in the actual drawing. Further, a splitting rule may cause a piece of a drawing to be outputted several times in split drawings from the drawing and/or information in a split drawing being less and/or other than in the drawing.

Although in the above it is assumed that one split drawing is outputted at a time, it should be appreciated that the splitting unit may be configured to output two or more split drawings with or without the drawing (“non-split” drawing).

The steps shown in FIGS. 2 and 3 are not in an absolutely chronological order, and they may be executed in a different order than given here, or simultaneously. Other functions may be carried out between the described steps or simultaneously with them. For example, after steps 206 and 222, when the annotations are obtained, it may be checked, whether or not the same annotations should be used (i.e. corresponding to step 308) and the annotations may be updated. Hence, it is easy to show additional information that facilitates the checking but that is not shown in the actual drawings. Examples of such additional information include control dimensions (i.e. dimensions with which one can easily verify that the dimensions to be shown in the drawing are proper ones), weld thickness, weld type, maximum size of aggregate and grade of concrete. Further, the outputted drawing view may be changed according to what is checked or manufactured so that it is easier for the user to piece together the part. Referring to FIG. 3, the process may be configured to maintain information on manufacturing, such as the user clicking the “ok” button after the phase is finished, and a corresponding signature may be stored. In an implementation, the outputted split drawings may be stored, for example for later retrieval. It is also possible to leave out some of the steps shown in the Figures, such as the ones where the signature is awaited and stored (steps 211 and 212) in FIG. 2. It is also possible to replace some of the described steps by a step that produces a corresponding end result. For example, when in the checking procedure the user has made a specific selection, the determination of the type of the part in step 216 may be replaced by determining the line in the check table for the part, after which the process proceeds to step 206 (i.e. steps 217 to 223 may be skipped and the end result is a corresponding one).

An advantage of maintaining and storing signature information is that it facilitates tracing when there is a need to find out later when and by whom something was performed.

As is evident from the above, outputting split drawings provides only relevant information that is easier to detect and is not hidden amongst all information. Hence, it helps to minimize the number of errors and increases productivity. Further, since split drawings are generated from drawing data, there is no need to take the splitting rule(s) into account in the actual modeling application or during creating or editing the model or when drawing data is created/updated. Hence, split drawings are even obtainable from models created with a modeling application without a splitting feature.

It will be obvious to a person skilled in the art that, as the technology advances, the inventive concept can be implemented in various ways. The invention and its embodiments are not limited to the examples described above but may vary within the scope of the claims.

What is claimed is:

1. A computerized method comprising:
maintaining in a memory a model comprising one or more object definitions and drawing data, wherein the one or more object definitions define corresponding one or more objects that are displayable in different model views via a user interface, the different model views being created using the one or more object definitions, and the drawing data defining, by means of drawing definitions, one or more drawings;
obtaining from the memory drawing data comprising drawing definitions defining a drawing for one or more of the one or more objects in the model, the drawing definitions including information relating to the one or more of the one or more objects in the model;
splitting the drawing data according to one or more splitting rules;
outputting at least one split drawing, the split drawing showing, as indicated by the splitting rule, at least one of the one or more of the one or more objects in the model and/or one or more pieces of the related information in a way other than it will be shown in the drawing.

2. A computerized method according to claim 1, further comprising:
detecting that the splitting has been triggered; and
obtaining the one or more splitting rules.

3. A computerized method according to claim 2, further comprising:
detecting a purpose of the splitting; and
selecting according to the purpose of the splitting the one or more splitting rules that are obtained.

4. A computerized method according to claim 1, further comprising:
maintaining information on whether or not a piece of the related information to be shown in the split drawing should be the same as a corresponding piece of the related information in the drawing; and
outputting the piece of the related information accordingly.

5. A computerized method according to claim 1, further comprising outputting in the split drawing additional information that is not outputted in the drawing.

6. A computerized method according to claim 1, further comprising:
providing an acknowledgement tool associated with the split drawing; and
in response to receiving a positive acknowledgement, storing information indicating at least the user who inputted the acknowledgment.

7. A computerized method according to claim 1, wherein the split drawing is for checking purposes, the splitting is triggered in response to detecting that one or more objects are indicated to be checked, and the one or more splitting rules define to output the indicated one or more objects, one or more pieces of the information relating to the indicated one or more objects and objects upon which the one or more pieces of the related information depend.

8. A computerized method according to claim 1, wherein the split drawing is for manufacturing drawing purposes, splitting is triggered in response to detecting that a phase in a manufacturing order is indicated, and the one or more splitting rules define to output one or more objects that are to be manufactured in the indicated phase or in each preceding phase and one or more pieces of information relating to the one or more objects that are to be manufactured in the indicated phase.

9. A computerized method according to claim 1, wherein a piece of the related information is an annotation.

10. A computerized method comprising:
maintaining in a memory a model comprising one or more object definitions and drawing data, wherein the one or more object definitions define corresponding one or more objects that are displayable in different model views via a user interface, the different model views being navigateable and created using the one or more object definitions, and the drawing data defining, by means of drawing definitions, one or more drawings;
obtaining from the memory drawing data comprising drawing definitions defining a drawing for one or more of the one or more objects in the model, the drawing definitions defining at least one drawing view from at least one of the one or more objects in the model and information relating to the at least one of the one or more objects and how the at least one drawing view and the related information is to be shown in the drawing;
splitting the drawing data according to one or more splitting rules;
outputting at least one split drawing, the split drawing showing, as indicated by the splitting rule, at least one of the one or more of the one or more objects in the model and/or one or more pieces of the related information in a way other than it will be shown in the drawing.

11. A method as claimed in claim 10, wherein
a model view is a 3D view,
a drawing view is a 2D view; and
the drawing definitions define a sheet size of the drawing and a table layout.

12. An apparatus comprising
at least one processor; and
at least one memory including computer program code;
the at least one memory and the computer program code being configured to, with the at least one processor, cause the apparatus at least to:
retrieve from a data storage one or more object definitions and drawing data, wherein the one or more object definitions define corresponding one or more objects in a model, the one or more object definitions providing information for creating different temporary 3D views of the model when the model is displayed, and the drawing data defining, by means of drawing definitions, additional information to be outputted in a drawing and one or more defined views for at least one of one or more engineering drawings and one or more manufacturing drawings and one or more 2D drawings for the model;
split the drawing data according to one or more splitting rules; and
output at least one split drawing, the split drawing showing, as indicated by the splitting rule, at least one of the one or more of the one or more objects in the model and/or one or more pieces of the additional information in a way other than it will be shown in the drawing.

13. An apparatus as claimed in claim 12, wherein the at least one memory and the computer program code are configured to, with the at least one processor, further cause the apparatus at least to retrieve, in response to detecting that splitting has been triggered, the one or more splitting rules from at least one of the one or more memories and the data storage.

14. An apparatus as claimed in claim 12, wherein the at least one memory and the computer program code are configured to, with the at least one processor, further cause the apparatus at least to:
detect a purpose of the splitting; and
select according to the purpose of the splitting the one or more splitting rules that are retrieved.

15. An apparatus as claimed in claim 12, wherein the at least one memory and the computer program code are configured to, with the at least one processor, further cause the apparatus at least to:
retrieve or receive as part of the one or more splitting rules information on whether or not a piece of the associated information to be shown in the split drawing should be the same as a corresponding piece of the associated information in the drawing; and
output the piece of the related information accordingly.

16. An apparatus as claimed in claim 12, wherein the at least one memory and the computer program code are configured to, with the at least one processor, further cause the apparatus at least to:
retrieve or received as part of the one or more splitting rules information on further additional information that is not in the drawing definitions; and
output in the split drawing the further additional information.

17. A computer program product embodied on a non-transitory distribution medium readable by a computer and comprising program instructions which, when executed by the computer, perform a computer process comprising:
obtaining from a memory drawing data comprising definitions defining a drawing for one or more objects in a model that is viewable by means of different model views, the definitions including information relating to the one or more objects;
splitting the drawing data according to one or more splitting rules;
outputting at least one split drawing, the split drawing showing, as indicated by the splitting rule, at least one of the one or more objects or one or more pieces of the related information in a way other than it will be shown in the drawing.

18. A computer program product according to claim 17, further comprising program instructions which, when executed by the computer, perform a further computer process comprising:
detecting a user input indicating a triggering of the splitting and a purpose of the splitting;
obtaining or selecting the one or more splitting rules that will be used in splitting according to the purpose.

19. A computer program product according to claim 17, further comprising program instructions which, when executed by the computer, perform a further computer process comprising:
detecting, from a received user input, a purpose of the splitting;
in response to the purpose being checking and a user input indicating one or more objects, outputting the indicated one or more objects, one or more pieces of the information relating to the indicated one or more objects and objects upon which the one or more pieces of the related information depend; and
in response to the purpose being manufacturing and a user input indicating a phase in a manufacturing order, outputting one or more objects that are to be manufactured in the indicated phase and/or in the indicated and each preceding phase and one or more pieces of information relating to the one or more objects that are to be manufactured in the indicated phase.

20. A computer program product according to claim 17, further comprising program instructions which, when executed by the computer, perform a further computer process comprising:
creating different temporary 3D views of the model when the model is displayed using object definitions in a modeling mode; and
outputting drawings and/or split drawings in a drawing mode.
